(19) United States
(12) Patent Application Publication
(10) Pub. No.: US 2022/0133559 A1
(43) Pub. Date: May 5, 2022

(54) MOTORISED MOBILITY DEVICE

(71) Applicant: Suzanne BREWER, London (GB)

(72) Inventors: Suzanne BREWER, London (GB); Jarvis SHEEHAN, London (GB)

(21) Appl. No.: 17/434,084

(22) PCT Filed: Feb. 12, 2020
(86) PCT No.: PCT/EP2020/053625

§ 371 Date: Aug. 26, 2021

(30) Foreign Application Priority Data
Feb. 27, 2019 (GB) 1902643.4

(51) Int. Cl. A61G 5/14; A61G 5/10; A61G 5/04; B62J 1/08; B62M 7/00; B62J 45/414; B62J 45/415; B62J 45/20

(52) U.S. Cl. CPC A61G 5/14; A61G 5/1059; A61G 5/041; B62J 1/08; B62J 2001/085; B62J 45/414; B62J 45/415; B62J 45/20; B62M 7/00

(57) ABSTRACT

A motorised mobility device including: a wheeled base; a saddle seat; and an adjustable support extending between the wheeled base and the saddle seat. The adjustable support is adjustable to raise the saddle seat from a sitting position to a standing position

### FIELD OF THE DISCLOSURE

The present disclosure relates to a motorised mobility device for facilitating movement of a mobility-impaired individual. In particular, the present disclosure relates to an adjustable sit/stand motorised mobility device.

### BACKGROUND

It is known that motorised mobility devices, such as electric wheelchairs, are used to enable individuals who suffer from a mobility impairment to retain some independent movement. An electric mobility device typically provides a flat seat for a seated user, the seat being secured on an electrically-powered wheeled base. The seated position of the user makes social interactions with standing, able-bodied individuals difficult. Some wheelchair mobility devices have an elevated seat where the user remains in a seated positon. However, a seated position can make it difficult to get close to objects and standing people. Further, a number of negative health problems are associated with prolonged sitting.

Upright mobility devices where the user is in a standing position are known. The user is typically secured to the mobility device with restraints such as belts or straps. Such restraints may impair upper body and limb mobility and may leave the user feeling restricted.

Some mobility devices are able to transition between seated position and standing/upright positions. Typically, the mobility device is provided with a flat seat and perpendicular back support in the seated position that unfold to lie in the same vertical plane to provide an elongated total body support in the standing position. Such arrangements require complicated and/or bulky mechanical arrangements to effect the transition. During transition, the centre of gravity of the mobility device will be moving laterally and longitudinally over the wheeled base. Accordingly, the wheeled base must be large. As a result, it may be difficult for the user to get close to objects and people, and the mobility device will require a large space to manoeuvre. Further, bulky mobility devices draw attention to the disability.

The present disclosure has been devised in light of the above considerations.

### SUMMARY

In a first aspect, there is provided a motorised mobility device comprising:
a wheeled base;
a saddle seat; and
an adjustable support extending between the wheeled base and the saddle seat,
wherein the adjustable support is adjustable to raise the saddle seat from a sitting position to a standing position.

By providing a saddle seat on an adjustable support, the user can sit on the saddle seat in the seated position and then raise the saddle seat to the higher standing position if movement in a standing position is desired. The user's legs will rest to either side of the saddle seat giving the impression that the user is standing freely. Unlike the known adjustable sit/stand devices, the user is supported on a seat in both the sitting and standing positions thus reducing the need for cumbersome restraints.

Optional features will now be set out. These are applicable singly or in any combination with any aspect.

In some embodiments, the wheeled base comprises two drive wheels e.g. only two drive wheels. The wheels may be mounted laterally on opposing lateral sides of the wheeled base. By providing a wheeled base with only two drive wheels, the footprint of the wheeled base can be reduced so that the user can position themselves in close proximity to people/objects.

Each of the drive wheels may be arranged to be independently driven (e.g. independently driven in both forward and backwards directions). For example, the wheeled base may comprise a respective motor associated with each of the drive wheels. This helps facilitate movement of the device in a small space.

The size of the drive wheels may assist in providing stability to the motorised mobility device. For example, the drive wheels may be at least 15 cm in diameter up to around 60 cm in diameter, such as between 30 cm and 45 cm in diameter, e.g. around 40 cm in diameter. Optionally, the drive wheels are fitted with tyres (e.g. non-slip and/or rubberised tyres). The tyres may be inflated tyres. The tyres may be between 5 cm and 20 cm wide (in an axial direction), such as between 10 cm and 15 cm wide and e.g. around 12.5 cm wide.

In some embodiments, the device (e.g. the wheeled base) may comprise one or more (e.g. two or more) stabiliser wheels.

Where there are drive wheels mounted to opposing lateral sides of the wheeled base, there may be one or more stabiliser wheel(s) mounted forward of e.g. on a forward edge (the forward edge extending between the opposing lateral sides) of the wheeled base. Additionally or alternatively, there may be one or more stabiliser wheel(s) mounted rearward e.g. on a rearward edge (the rearward edge extending between the opposing lateral sides) of the wheeled base.

In some embodiments, the one or more stabiliser wheel(s) may be directly attached to the wheeled base.

In other embodiments, the or each stabiliser wheel may be attached to the device (e.g. to the wheeled base) via a respective extension arm. The or at least one of the extension arm(s) (e.g. two extension arms) may extend forward of the wheeled base. The or at least one of the extension arm(s) (e.g. two extension arms) may extend rearward of the wheeled base. The extension arms(s) may be connected directly to the wheeled base or may be connected to a sleeve at least partly encircling the adjustable support (e.g. proximal the wheeled base).

Optionally, one or more of the or each of the stabiliser wheels may be a castor wheel or a jockey wheel. In some embodiments, the or each stabiliser wheel may be unpowered i.e. free-wheeling.

The or each stabiliser wheel may be attached to the wheeled base or to the respective extension arm by a suspension element e.g. a coiled spring, to assist the stabiliser wheel maintain contact with an uneven surface.

Typically, the stabiliser wheel(s) may be smaller than the drive wheels. For example, the stabilizer wheel(s) may be 5 cm to 30 cm in diameter, such as 15 cm to 25 cm in diameter, e.g. around 20 cm in diameter.

Optionally, the wheeled base may be provided with a protective casing.

Optionally, the device may be provided with a foot rest. In some embodiments, a foot rest is provided extending laterally between two forwardly-extending extension arms each bearing a stabiliser wheel. The footrest may be suspended from the extension arms and may be aligned with the stabiliser wheels.

In some embodiments, the wheeled base includes a CPU (central processing unit) for providing an output signal to control the motors associated with the drive wheels in order to independently adjust the rotation speed and/or direction of the drive wheels.

In some embodiments the wheeled base is self-stabilising or self-balancing. The device may comprise one or more sensors to monitor the positional state of the wheeled base e.g. to monitor tilt. The sensor(s) may include one or more accelerometer, one or more gyroscope, one or more yaw or tilt sensor and combinations thereof.

Optionally, the sensor(s) may provide input data to the CPU (central processing unit). The CPU can process the input data from the sensor(s) and providing an output signal to control the motors associated with the drive wheels in order to independently adjust the rotation speed and/or direction of the drive wheels to ensure balancing of the device (i.e. to maintain the centre of gravity of the device and user above the wheeled base).

Optionally, the wheeled base and self-stabilising system may be a Segway™-style wheeled base and system.

The adjustable support is mounted to the wheeled base. The adjustable support may be extend substantially vertically from the wheeled base.

In preferred embodiments, the adjustable support is axially adjustable to increase and decrease its axial length (e.g. adjustable only in an axial direction) between the sitting and standing positions. The adjustable support has an extended configuration when the saddle seat is in the standing position and a retracted configuration when the saddle seat is in the sitting position.

Thus during adjustment of the saddle seat between the sitting and standing positions, the saddle seat moves in a single (vertical) dimension. The saddle seat is fixed in a horizontal plane, relative to the wheeled base. This arrangement ensures that the centre of gravity of the motorised mobility device is maintained substantially over the wheeled base in both in the sitting position and the standing position.

The adjustable support and wheeled base may be configured such that the saddle seat is at a height of between 40 and 50 cm (e.g. around 45 cm) in the sitting position and between 90 and 100 cm (e.g. around 95 cm) in the standing position. Thus the difference in axial length between the sitting and standing positions may be at least 40 cm, e.g. at least or around 50 cm.

In some embodiments the adjustable support may be a piston e.g. a pneumatic or hydraulic piston, adjustable using compressed fluid. Optionally, the piston may comprise a sealed cylinder (e.g. a double-acting cylinder) containing compressed fluid that acts on a piston rod. A cylinder type piston is able to extend and retract in an axial direction, and as a result the adjustable seat is movable from the sitting position to the standing position or from the standing position to the sitting position. The ‘cylinder’ may have a non-circular cross-section. For example, the ‘cylinder’ may have a substantially rectangular cross section.

In order to achieve the necessary range of movement of the adjustable support between the sitting position and the standing position, the adjustable support may comprise a multi-stage, telescoping piston cylinder where the stages increase or decrease in diameter from the base (proximal the wheeled base) to the top (proximal the saddle seat) such that the smaller of two adjacent stages can be slidably received (nested) within the larger of the two adjacent stages in order to reduce the axial length of the support. For example, the adjustable support may comprise a multi-stage telescoping piston cylinder comprising four stages.

Typically, the stage decrease in diameter from the base to the top to provide the widest base and therefore the most stable arrangement.

In other embodiments, the adjustable support may comprise a screw mechanism (e.g. a screw jack) where relative movement of cooperating threads can be used to adjust the vertical length of the adjustable support to move between the sitting and standing positions. The adjustable support may comprise a ratchet mechanism.

In some embodiments, the adjustable support may be provided with one or more sensors in order to monitor the extension of the adjustable support. These sensors may provide an output signal to the CPU.

In preferred embodiments, the saddle seat is centrally mounted on the adjustable support e.g. on the piston rod of the adjustable support. As a result, the centre of gravity will remain substantially over the base of the adjustable support and the motorised mobility device will remain stable. The saddle seat may comprise a mount for receiving the piston rod (i.e. the opposing end of the piston rod to that received in the piston cylinder). The mount may comprise a lever allowing pneumatic adjustment of the piston rod within the mount. This may be used to manually effect slight changes in the height of the saddle seat above the wheeled base.

The saddle seat comprises a central portion (which extends/is for engagement between a user's thighs). The saddle seat may also include downwardly-extending flank portions. In use, the user straddles the central portion and the user's thighs engage/rest against the flank portions allowing their legs to be extended in a downward direction either side of the central portion.

The saddle seat may comprise a raised and/or rounded nose portion forward of the central portion.

The saddle seat may comprise a rear portion rearward of the central portion. The rear portion may be raised. Where there are raised nose and rear portions, the central portion sits in a depression in the saddle seat which increases stability for the user.

The downwardly-extending flank portions may be provided on the central portion and may be laterally opposed so that the user straddles the central portion with their inner thighs engaging/resting against the flank portions.

Alternatively/additionally, the downwardly-extending flank portions may be provided on the rear portion. For example, the rear portion may comprises two arms (e.g. two cantilevered arms) which extend laterally (optionally with a downwardly curving profile) to the rear and either side of the central portion. The flank portions may be formed by the forward edges of these rear portion arms. The user can rest their buttocks upon the rear portion arms with the central portion between their inner thighs and the rear of the user's thighs resting against the flank portions on the rear portion arms.

The saddle seat may comprise padding formed of foam (e.g. memory foam) or may comprise a gel- or air-filled covering.

Optionally, the motorised mobility device may further comprise a back support for providing upper body support. Optionally, the motorised mobility device may further be provided with a head support. The back support and/or head support may be substantially perpendicular to the saddle seat. The motorised mobility device may comprise one or more arm-rests.

Optionally, the motorised mobility device may be provided with safety restraints such as a seat belt and/or harness e.g. a three point seat belt.

A power source for the motorised mobility device may comprise one or more batteries e.g. two batteries contained within the wheeled base. Optionally, the batteries may be rechargeable.

Optionally, the power source may be comprise a kinetic energy recovery system such as a dynamo, to recharge the batteries in during use. Optionally, the power source may be provided with solar panels to recharge the batteries.

User controls (e.g. a joystick and/or a touch screen interface and/or electronic control pad) may be mounted proximal to the saddle seat. In some embodiments, the controls may be provided on an arm-rest (where present). For example, a first arm rest may be provided with a first user control (e.g. a joystick) for controlling motion of the mortised mobility device and a second arm rest may be provided with a second user control (e.g. one or more buttons) to control extension and retraction of the adjustable support to adjust the axial height.

Preferably, the user controls provide an input to the CPU and the CPU responds to the user controls. Outputs from the CPU drive the motor(s) of the drive wheels to direct motion of the wheeled base according to user input via the controls. Further, outputs from the CPU may adjust the axial height of the adjustable support.

In preferred embodiments, the motorised mobility device may be detachable into its component parts. This facilitates storage and makes the device easier to fit into a vehicle. For example, the saddle seat may be detachable from the adjustable support and/or the adjustable support may be detachable from the wheeled base. In addition/alternatively, the drive wheels may be detachable from the wheeled base.

The disclosure includes the combination of the aspects and preferred features described except where such a combination is clearly impermissible or expressly avoided.

In a second aspect, there is provided a method of using a motorised mobility device comprising providing a mobility device according to the first aspect and adjusting the axial length of the adjustable support to raise the saddle seat from the sitting position to the standing position.

Thus the method comprises adjusting the vertical height of the saddle seat above the wheeled base. Thus during adjustment of the saddle seat between the sitting and standing positions, the saddle seat moves in a single (vertical) dimension.

In some embodiments, the method comprises independently controlling the speed and/or direction of the drive wheels provided on the wheeled base.

In some embodiments, the method comprises monitoring the positional state (e.g. tilt) of the wheeled base using one or more sensors optionally selected from one or more accelerometer, one or more gyroscope, one or more yaw or tilt sensor and combinations thereof.

In some embodiments, the method further comprises providing input data to a CPU (central processing unit) from the sensor(s) and providing an output signal to control speed and/or direction of rotation of the drive wheels e.g. by controlling the motors associated with each drive wheel.

### SUMMARY OF THE FIGURES

Embodiments and experiments illustrating the principles will now be discussed with reference to the accompanying figures in which:

FIG. 1 illustrates a first example of a motorised mobility device; and

FIG. 2 illustrates a second example of a motorised mobility device.

### DETAILED DESCRIPTION

Aspects and embodiments will now be discussed with reference to the accompanying figure.

Further embodiments will be apparent to those skilled in the art.

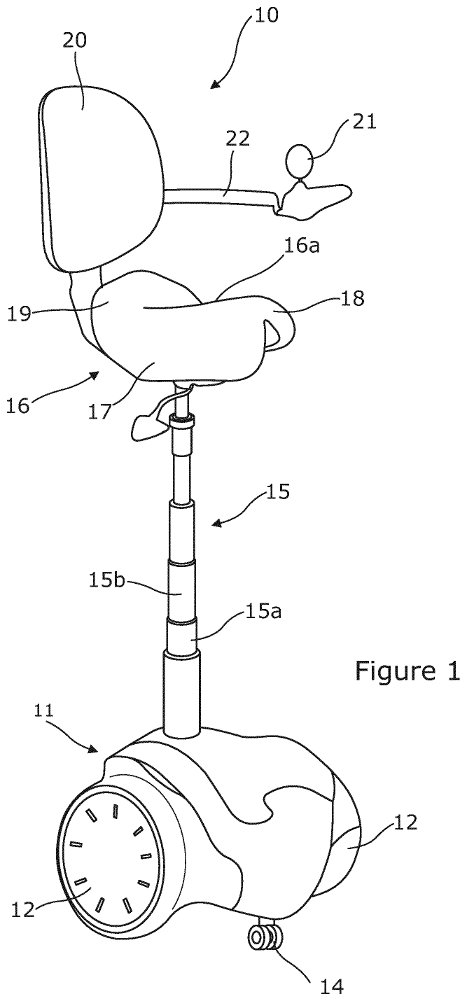

FIG. 1 illustrates an example of a motorised mobility device 10 shown in the standing position.

The mobility device 10 has a wheeled base 11, comprising two laterally-attached drive wheels 12. The wheeled base 11 further comprises a castor-type stabiliser wheel 14, located on a forward edge of the wheeled base between the drive wheels 12. The drive wheels 12 are around 50 cm in diameter and the stabiliser wheel 14 is around 10 cm in diameter.

An adjustable support 15 is mounted on the wheeled base 11. The adjustable support 15 extends substantially vertically from the wheeled base 11. The adjustable support 15 comprises a multi-stage telescoping cylinder piston. The first piston stage 15a, closest to the wheeled base 11, has the largest outer diameter. The adjacent piston stage 15b in the series has an outer diameter corresponding to the inner diameter of the first piston stage 15a. The subsequent stages of the piston are arranged similarly in sequence. As illustrated in FIG. 1, the adjustable support 15 is in the standing position where the telescoping cylinder piston is extended. The adjustable support 15 is able to collapse/retract to the sitting position, with the cylinder stages 15a, 15b etc. nested within each other.

A saddle seat 16 is attached to the top of the adjustable support 15, at the distal end from the wheeled base 11. The saddle seat 16 comprises a central portion 16a with laterally opposing downwardly-extending flank portions 17, a raised, rounded nose portion 18, and an upwardly-depending rear portion 19.

Extending from the rear of the saddle seat 16, there is a back support 20 for providing body support to a user when seated on the saddle seat 16.

User controls 21 are arranged at the distal end of an arm-rest 22 extending from the back support 20. The controls 21 are within manual reach of a user. The controls 21 allow the user to provide inputs to a CPU (not shown) to control the drive wheels 12 and to adjust the height of the saddle seat 16 by expanding or collapsing the adjustable support 15.

The user mounts the saddle seat 16 in the sitting position with the adjustable support 15 in its retracted position. The user control 21 are used to extend the adjustable support to increase its axial length. Thus the saddle seat 16 is vertically raised (without any lateral/horizontal movement) to the standing position. In this position, the user's legs will extend substantially vertically downwards either side of the flank portions 19 of the saddle seat 16 thus giving the appearance that the user is standing unaided.

In fact, the saddle seat will provide the necessary support. Movement of the device 10 is effected by rotation of the drive wheels 12 controlled by the user controls 21 via the CPU. Rotation of the device is effected by driving one drive wheel faster than the other (indeed, one wheel may be kept static and only one wheel may be driven). The independent control the speedo/direction of the drive wheels 12 rotation also helps ensure that the device maintains stability. Gyroscope sensors provided in the wheeled based 13 will provide signals to the drive wheel 12 motors via the CPU to ensure stability is maintained.

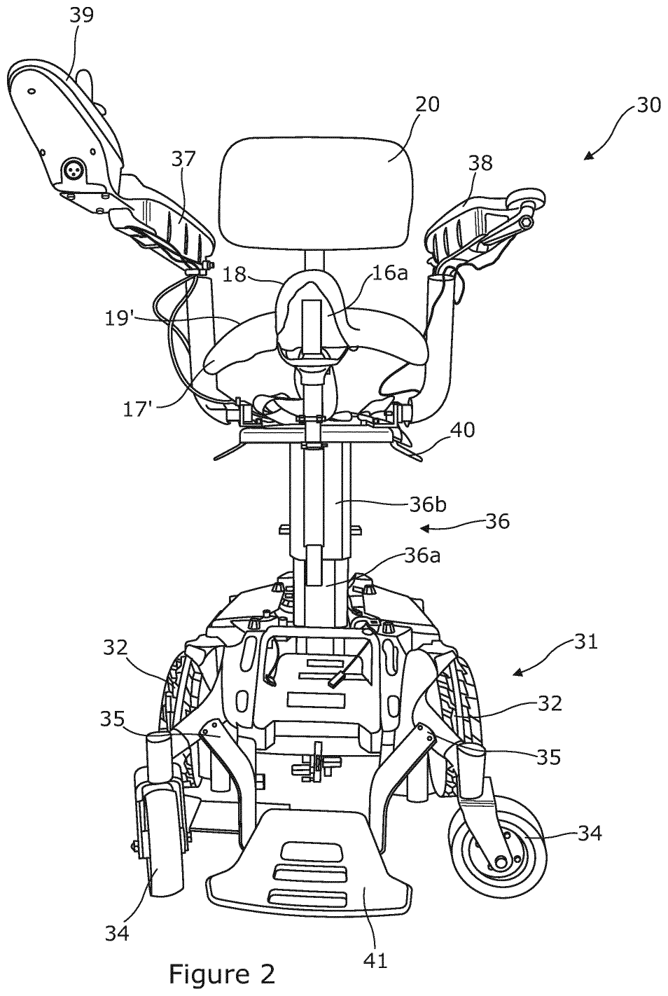

FIG. 2 illustrates an example of an alternative motorised mobility device 30 shown in the standing position. For brevity similar features are not described again. The motorised mobility device 30 has a wheeled base 31 stabilised between drive wheels 21 and stabiliser wheels 34 rather than a Segway™-style wheeled base 11 as illustrated on the motorised mobility device 10 of FIG. 1.

The two stabiliser wheels 34 are each located on respective extension arms 35. The drive wheels 32 are around 50 cm in diameter and the stabiliser wheels 34 are around 10 cm in diameter.

The two extension arms 35 extend from the wheeled base 31 forward of the drive wheels 32.

A footrest 41 depends from the extension arms 35 and extends laterally between the stabiliser wheels 34.

The mobility device 30 is provided with an adjustable support 36 mounted on the wheeled base 31. The adjustable support 36 extends substantially vertically from the wheeled base 31. The adjustable support 36 comprises a multi-stage telescoping cylinder piston. The first piston stage 36a, closest to the wheeled base 31, has the smallest outer diameter. A second piston stage 36b in the series has an inner diameter corresponding to the outer diameter of the first piston stage 36a. As illustrated in FIG. 1, the adjustable support 36 is in the standing position where the telescoping cylinder piston is extended. The adjustable support 36 is able to collapse/retract to the sitting position, with the cylinder stages 36a, 36b nested within each other.

The mobility device 30 is further provided with a saddle seat. This saddle seat comprises a central portion 16a and a rounded nose portion 18. There are two cantilevered rear portion arms 19′ on which the user can rest their buttocks with their legs hanging down either side of the central portion 16a. The rear portion arms 19′ each have a forward edge which form downwardly-extending flank portions 17′ against which the rear of the user's thighs can rest/engage.

The mobility device is also provided with first and second arm rests 37, 38. The arms 37, 38 are attached to the top of the adjustable support 36 and extend around the saddle seat 16 so that rest portions are arranged laterally from and above the level of the saddle seat 16. The first arm rest 37 is provided with a joystick 39 to control motion of the motorised mobility device, and the second arm rest 38 is provided with buttons (not shown) to control the adjustable support 36. The saddle seat 16 is further provided with a back rest 20, as illustrated in FIG. 1.

The mobility device 30 is detachable into two parts. A locking/unlocking mechanism 40 is provided between the adjustable support 36 and the arms 37, 38 and saddle seat 16 to allow the saddle seat 16 and arms 37, 38 to be detached from the adjustable support 36.

Many equivalent modifications and variations will be apparent to those skilled in the art when given this disclosure. Accordingly, the exemplary embodiment set forth above is considered to be illustrative and not limiting. Various changes to the described embodiment may be made.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A motorised mobility device comprising:
a wheeled base;
a saddle seat; and
an adjustable support extending between the wheeled base and the saddle seat,
wherein the adjustable support is adjustable to raise the saddle seat from a sitting position to a standing position

2. The device according to claim 1, wherein the adjustable support extends substantially vertically from the wheeled base.

3. The device according to claim 1 wherein the adjustable support is axially extendable between a retracted configuration in the sitting position to an extended configuration in the standing position.

4. The device according to claim 1, wherein the adjustable support is a hydraulic piston or pneumatic piston.

5. The device according to claim 4, wherein the hydraulic piston or pneumatic piston comprises a multi-stage telescoping piston cylinder.

6. The device according to claim 1, wherein the wheeled base comprises two independently driven drive wheels.

7. The device according to claim 1 wherein the wheeled base comprises one or more sensors selected from one or more accelerometer, one or more gyroscope, one or more yaw or tilt sensor and combinations thereof.

8. The device according to claim 1, wherein the saddle seat is fixed in two dimensions relative to the wheeled base.

9. The device according to claim 1, wherein the saddle seat comprises a central portion for engagement between a user thighs.

10. The device according to claim 1, wherein the device is detachable into two or more parts.

11. A method of using a motorised mobility device comprising providing a mobility device according to claim 1 and adjusting the axial length of the adjustable support to raise the saddle seat from the sitting position to the standing position.

12. The method according to claim 11 comprising independently controlling the speed and/or direction of drive wheels provided on the wheeled base.

13. The method according to claim 11 comprising monitoring the positional state of the wheeled base using one or more sensors selected from one or more accelerometer, one or more gyroscope, one or more yaw or tilt sensor and combinations thereof.

14. The method according to claim 13 further comprising providing input data to a CPU from the sensor(s) and providing an output signal to control speed and/or direction of rotation of the drive wheels.

15. The method according to claim 11 comprises adjusting the axial length of the adjustable support such that the saddle seat moves in a single (vertical) dimension.

16. The device according to claim 1, wherein the adjustable support comprises an electric drive.

17. The device according to claim 1, wherein in the sitting position, in use, a user is seated on the saddle seat and in the standing position, in use, the user is seated on the saddle seat.

18. The device according to claim 1, wherein the adjustable support extends no further than between the wheeled base and the saddle seat.

19. The device according to claim 1, wherein the lower side of the saddle seat is mounted on the adjustable support, the lower side of the saddle seat being opposite to the side of the saddle seat for sitting on.

20. The device according to claim 1, wherein the device is an electric wheelchair for a mobility impaired user.
